(19) United States
(12) Patent Application Publication
(10) Pub. No.: US 2016/0042091 A1
(43) Pub. Date: Feb. 11, 2016

(54) System And Method Of Forming An Index

(71) Applicant: Mukul Pal, New Delhi (IN)

(72) Inventor: Mukul Pal, New Delhi (IN)

(21) Appl. No.: 14/574,507

(22) Filed: Dec. 18, 2014

(30) Foreign Application Priority Data
Aug. 7, 2014 (IN) 2251/DEL/2014

(51) Int. Cl. G06F 17/30; H04L 29/08; G06N 5/04

(52) U.S. Cl. CPC G06F 17/30946; G06N 5/04; H04L 67/10

(57) ABSTRACT

The invention discloses a computer implemented method of forming an index that comprises of a set of variables that are formed by filtering a first set of variables on condition set to form a second set of variables, wherein a resource is proportionately allocated to each of the variables of the second set of variables in proportion to the weights assigned, and analyzing the performance of each of the variables in the second set of variables after an exit time interval and rebalancing the second set of variables, wherein the components of the second set of variables are rebalanced with the components of the first set of variables based on exit conditions.

### FIELD OF INVENTION

The present invention is generally related to a system and method for forming an index of variables and is more particularly related to the method and system for analyzing variables in a group of variables to predict the performance of the variable and various group of variables based on risk and time preferences.

### BACKGROUND

Some attempts have been made to develop methods designed to analyze performance of a variable with dynamic value associated with it rather using known mathematical techniques or statistical techniques. However, there has been no credible attempt to analyze a group of variables based on risk and time preferences. Here, a group of variables may be defined as a collection of components of a certain variable (or variables), which could be statistically correlated or uncorrelated, homogeneous or heterogeneous i.e. with similar or different characteristics such as statistical, scientific, economic, financial, technical, fundamental, behavioral, sentimental, geological, navigational, historical, legal, corporate, business, survey, social media, market research etc. Some examples of variable may represent data including but not limited to a web search data, sentiment data, consumer data, economic data, financial data, and stock market data. Moreover the dynamic value attached with such data variables may include but not limited to monetary or non-monetary values, frequency values, volume numbers, unitary numbers, percentiles, absolute numbers and relative figures. Examples of variables include but are not limited to equities, debt instruments, equity market indices, derivatives, currency, financial object or any data set associated with an organic underlying such as a weather data over a period of time, number of hits at a website in one day, trending issues over Twitter™ in last 24 hrs, trending websites and other dynamically changing values of a variable in last week.

Hence, what is needed therefore is a system and method for predicting performance or trend of a variable or various groups of variables over certain time period and/or different periods of time, wherein the dynamics of a group of variables is analyzed and predictions are based on collective performance of the variables over a period of time.

### SUMMARY

The present invention provides a method and system for forming an index to determine trends of the data variables.

According to an embodiment of the invention, the method of forming an index, comprising the steps of: selecting a first set of variables, wherein the first set of variables is selected from a group of variables; ranking the first set of variables on a ranking time period; selecting a second set of variables based on a condition set, wherein the second set of variables form the variables of the index, wherein the second set of variables is selected from the first set of variables; assigning weights to each of the variables of the second set of variables, wherein a resource is proportionately allocated to each of the variables of the second set of variables in proportion to the weights assigned; analyzing the performance of each of the variables in the second set of variables after an exit time interval, wherein indexed value of the variables in the second set of the variables is measured; and repeating the steps of ranking, selection of second set of variables, assignment of weights and analyzing for a defined period of time, wherein the second set of variables is a dynamic set of variables forming the index.

### BRIEF DESCRIPTION OF THE DRAWINGS

FIG. 1 is a diagram depicting an Indexing system and the other elements and the environment of the invention, according to an embodiment of the invention.

FIG. 2 is a flowchart that illustrates steps to build an index from a first set of variables according to an embodiment of the invention.

FIGS. 3A and 3B are flowcharts that illustrate steps to build an index for a first set of variables according to an embodiment of the invention.

### DETAILED DESCRIPTION

The exemplary embodiments, described in this section with details, are provided merely to illustrate the principles of the invention. Various details are set forth for the purpose of explanation rather than limitation. However it will be apparent to a person skilled in the art that the invention can be practiced without these details and the given exemplary embodiments should not be construed as limiting the scope of the invention. Some of the terms as used in the patent application have been described below without limiting the scope of the invention.

### DEFINITIONS

Indexing—Indexing is a statistical measure of storing a change in a variable or variables as a single value or sequence of values recorded in a unit of time. Thus an index could be a portfolio (basket) of variables representing a particular group (or groups) or a portion of it. Each index has its own calculation methodology and could be expressed in terms of a change from a base value.

Database—Database is an organized collection of data and information that is structured so that it can easily be accessed, managed, and updated. The databases are classified according to their organizational approach into database models such as relational database or an object-oriented programming database model with the data defined in object classes and subclasses. Some other types of database models includes but not limiting to semi-structured model, hierarchical model, network model, associative model, entity-attribute-value model and context model.

Time Period—Time period ordinarily refers to any period of time to measure changes in the value of a dynamic variable. The time period may be measured in micro seconds, minutes, hours, days, months or years or any fraction of these time periods.

Server—A server is a physical computer (a computer hardware system) or a virtual machine (software implementation of a machine that executes programs like a physical machine) dedicated to running one or more services (as a host) to serve the needs of users of the other computers on the network. Depending on the computing service that it offers it could be a database server, file server, mail server, print server, web server, or any other computing server.

In an embodiment of the invention, a variable, which is an instance of a data variable, is used to describe the working of the system. The intent and meaning of the terms—‘data variable’, ‘component’ and ‘variable’ are interchangeable as for the purpose of describing the invention. The variables dynamic in nature and has an associated value at any particular time, hereinafter referred to as ‘variable value’. The variable value changes with time, depending on various factors and conditions. Examples of a variable includes but not limited to web search data, sentiment data, consumer data, economic data, financial data, stock market data, financial objects such as currency, equity, debt instrument, a bond, a stock, a financial instrument, a contract, a security, a derivative contract, a mutual fund, an exchange traded fund (ETF), a secondary market fund, a penny stock, any listed instrument, an unlisted instrument, debt instrument, mortgage instrument, real-estate linked investment instrument, a fund of funds, an index fund, a passive index fund, an enhanced index fund, an actively managed fund, a non-capitalization weighted index fund, a capitalization weighted index fund, an equal weighted indexed fund, an international fund, a sector fund, a variable, a liability, an accounting data based index (ADBI) fund, a portfolio of variables, a portfolio of variables tracking an index, a portfolio of variables tracking at least one of S&P indexes, FTSE indexes, Russell indexes, Dow Jones indexes, Morgan Stanley indexes, Lehman indexes, Wilshire indexes, composite indexes, international indexes, or Morgan Stanley Capital International indexes, a portfolio of variables tracking an ADBI weighted index, a commodity, an option, a derivative trade, a long hedge, a short hedge, a swap, a futures contract, or a hedge fund, economic data. It may again be emphasized that the present invention is not limited by list of variables or data variables, mentioned in the description, rather it is applicable to any dynamically changing values of a variable or the data variable. Further, examples of the variable values includes but not limited to equity prices, futures data, spreads between equities, data about product sales, sentiment data about brands, inventory data and any other financial or non-financial data about data variables in a group of data variables which are dynamic in nature and that change over time and event triggers.

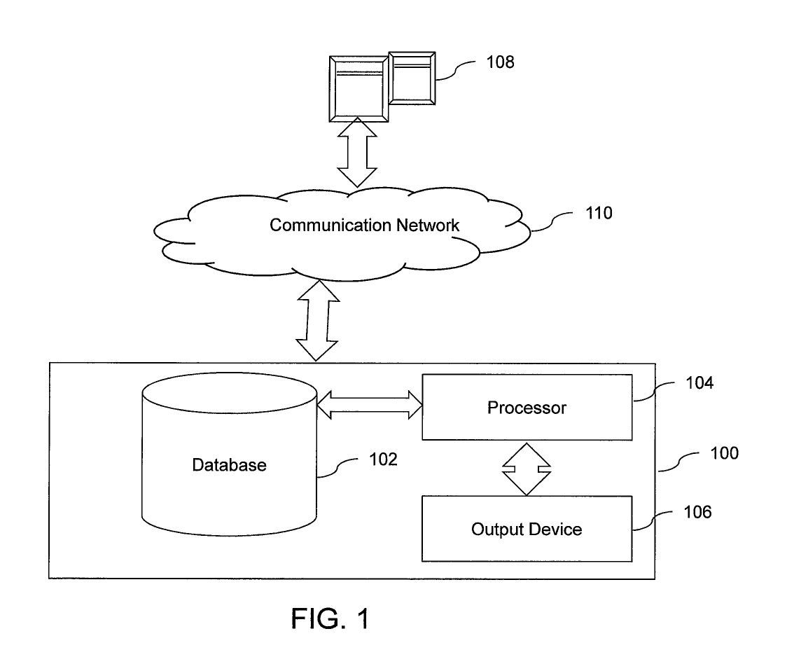

FIG. 1 discloses an Indexing system 100 and the elements of the invention, according to an embodiment of the invention. The Indexing system 100 comprises of a database 102, a processor 104 and an output device 106. The Indexing system 100 is capable of indexing by constructing an Index or a set of filtered variables from a universe of variables, which collectively represent an Index value, stored in a distributed database 108 in a communication network 110. Further, that the Indexing system 100 may be provided with inputs from a user or administrator of the Indexing system 100 through an input-output medium 106. It may be noted that ‘user’ and ‘administrator of the Indexing system 100’ have been used interchangeably in the present patent description and the meaning and intent of both the phrases is same. The input-output medium 106 may include a computer system, mobile device, tablet, external server, a key-board and monitor system or any other system that can be used to communicate with the processor 104.

The universe of variables has all the possible types of variables, as exemplified above and is stored in the distributed database 108. The distributed database 108 may be a database server or a group of databases and processors hosted at various locations over the communication network 110. Thus, the distributed database 108 includes but is not limited to remote computer systems, remote processing and storing devices, datacenters, databases and other sources that have the dynamic information on the variable value. The examples of server 110 may be storage centers such as Stock Exchange servers, for example, NASDAQ OMX Data Center, FTSE Data Server or other storage centers such as Google™ database server and the likes. In an embodiment of the invention, the variables are stored at multiple places and can be accessed by the Indexing system 100 over the Internet, Cloud, standalone networks, Intranet or any other network systems.

The variable values for plurality of variables stored in the distributed database 108 are fetched by the processor 104 and is stored in the database 102. The database 102 is capable of capturing and storing plurality of variable values along with associated time stamp (value of time when the variable value was captured). The database 102 is also capable of storing the results of the processor 104. It may be evident to a person skilled in the art that the scope and intent of the invention is not limited by the capability of the database 102. The plurality of variables and the associated variable values are fetched by the processor 104 from the distributed database 108 and stored into the database 102.

The processor 104 fetches a first set of variables from the distributed database 108 and stores them in the database 102. The first set of variables is a homogeneous set of data variables for instance, equities that are fetched from the distributed database 108. The homogeneous set of variables refers to those variables whose variable values can be compared.

In an embodiment of the invention a plurality of variable values are stored in the database 102 for a plurality of time stamps over a pre-determined period of time for each of the variables in the first group of variables, which are then processed for forming an index of the variables. Each index has its own calculation methodology and could be expressed in terms of a change from a base value. The value of each of the components of the first set of variables maybe normalized with respect to a base value. Such values of the variables can also be referred to as the indexed value of the component. The value of the index is thus measured by calculating the total indexed value of the components in the first set of variables. Further, the initial value of the index (or the first set of variables or a basket) can be any notional value, measured in monetary or non-monetary terms. This initial value of the index or the first set of variables or the basket is base value of the index. The initial value of the index changes in time and maybe referred to as the current value of the index.

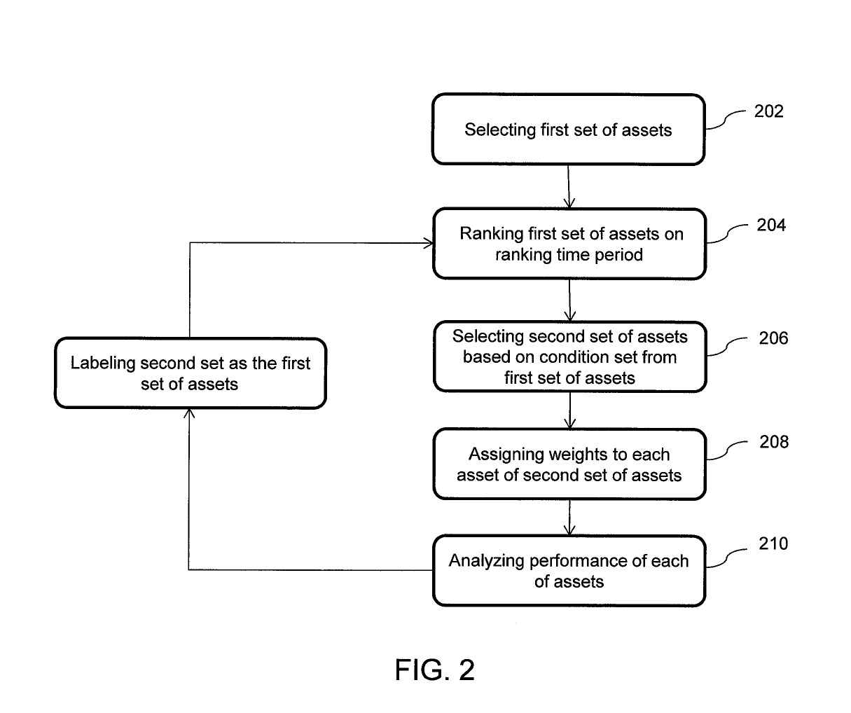

FIG. 2 depicts steps to build an index from a first set of variables according to an embodiment of the invention. The step 202 involves selecting the first set of variables, wherein the first set of variables is selected from the universe of variables. According to an embodiment of the invention, the first set of variables comprises of sentiment data. The sentiment data for a company (for instance Auto industry) is when the name of the company appears on selected internet sources including but not limited to news articles, twitter mentions and other social media websites. Further, the variable value here may be the frequency or the number of times, the name of the company is mentioned on different sources. Thus, according to the embodiment of the invention, the first set of variables comprises of sentiment data for different companies in the auto sector. Further, as an instance, the initial value of the first set of variables may be defined as the daily frequency for J companies in auto sector for a period of T days, wherein J and T may be any numerical values programmed in the Indexing system 100 or provided as input by the administrator of the Indexing system 100. As a specific instance for illustration, we can choose J=100. Thus, the processor 104 fetches the names of the 100 companies and the corresponding sentiment data value from the Internet server (the distributed database 108).

At step 204, the processor ranks the first list of variables having 100 companies and their sentiment data value, based on the ranking algorithm, Indian Patent Application No. 1844/DEL/2013 on a percentile basis. This ranking algorithm assigns the most frequent company (thus having highest sentiment data value) a score of 100 and the least occurring company is assigned score of 1. The ranking algorithm, according to an embodiment, ranks the first set of variables comparing the sentiment data value over a period of time, or the indexed value of the sentiment data value over the time.

After the first set of variables has been ranked, at the next step 206, the processor 104 selects a second set of variables from the first set of variables based on a condition set wherein the second set of variables forms the dynamic variables of the index. Conditions are based on Variable Value, Ranking of variable value, Basket (portfolio) value, ranking basket (portfolio) value, characteristic or a combination of conditions. These conditions determine the acquiring (Entry) and or discarding (Exit) of a component in or out of a basket (portfolio) or the first set of variable. The condition set comprises both a ranking filter and a variable value filter, with of one or more conditions to select variables from the ranked first set of variables. For example, the ranking filter may specify that the processor 104 selects those variables from the ranked first set of variables, which are:
a. in the top X % ranked variables by variable value in the first set of variables, wherein 0<X<100; and
b. the ranking period is restricted to K months, wherein K is any time period in months,
   Further, the variables may be filtered by specifying one or more conditions on the sentiment data value movement of the companies. For example,
c. N period DMA Variable Value (Daily Mean Average value of the company for N time periods) is greater than or M Period DMA Variable value (Daily Mean Average value of the company for M time periods) of the company is less than the sentiment data value of the company, wherein M and N are time periods in months and may be specified by the user. Further, it would be apparent to a person skilled in the art that M and N may be specified in minutes, hours, days or any other unit of time.

The processor 104 then selects the variables from the ranked first set of variables to form a second set of variables based on condition sets comprising condition a, b and c. Thus the condition set may be single or multiple. The condition sets may be either programmed or scheduled or may be provided by the administrator of the Indexing system 100 through the input-output medium 106. Specific examples of the condition set are described in conjunction with the embodiments of the invention in the description below.

In the next step 208, the processor 104 tests the first set of variables for entry conditions. Thus, the elements of the first set of variables are tested for the entry conditions comprising ranking and variable value filter. For example, the entry conditions may specify condition to acquire 10 companies to create the index on time period 1 given a base value of 100.

Further, the processor 104 assigns weights to each of the variables of the second set of variables according to weighing algorithm or allocation rules. The allocation refers to assigning a unit or plurality of units in percentile, numeric, currency, notional, discretionary, monetary or non-monetary terms to a component or a variable from the second set of variables or the basket or portfolio of variables. This allocation defines the component or the plurality of components' weight in the basket of variables or the second set of variables. It may be apparent to a person skilled in the art that the weight or weightings can be equal, unequal, discretionary, proportional, disproportional, condition based and the like. Further, a resource is proportionately allocated to each of the variables of the second set of variables in proportion to the weights assigned according to allocation rules, defined by the administrator of the Indexing system 100. The resource may refer to units, points or cash, which can be allocated to different elements of the second set of variables in accordance with the allocation rules for the objective evaluation of the second set of variables. For example, the administrator of the Indexing system 100 may allocate equal resources to the 10 new companies. Examples of the user defined algorithm are described in conjunction with the embodiments of the invention in the description below.

Further, after an exit time interval when the performance of each of the variables in the second set of variables as well as performance of the index (combined performance of the second set of the variables) is analyzed by the processor 104. The variables of the second set of variables form components of the index at any point time. The exit time period is user defined or may be determined by an algorithm defined in the processor 104. The user or administrator may provide the exit time through the input-output medium 106. After the exit time period, the performance of the second set of variables is evaluated based on exit conditions. Here the second set of variables are rebalanced by replacing an underperforming (or outperforming or as the Indexing preference may specify) variable in the second set of variables with another variable (based on the Indexing preference) from the first set of variables. Thus, rebalancing involves the process of realigning the weightings of the components in the basket or the second set of variables. Thus, there is periodic acquiring or discarding of components or variables from the first set of variables to maintain an original desired level of weighting. For example, the exit conditions may comprise of comparing the net variable value of the second set of variables for a time period one with the net variable value of the second set of variables for a time period two, wherein time period one and time period two are time intervals that are provided by the user. Thus, performance measurement of the second set of variable at the end of the exit time period is defined by the user based on the user defined exit conditions. Further, based on performance criteria, variables may be replaced from the second set of variables with the variables from the first set of variables. The performance criteria may again be programmed into the processor 104. The performance criteria may define if the current performance of the index is say 20% less than the previous performance. It may be apparent to a person skilled in the art that any other performance criteria to rebalance the index may be used. Further, the cumulative variable value of the second set of variables determines an index value of the second set of the variables. The rebalanced second set of variables thus form the dynamic set of variables.

In the next step 210, steps 202 to step 208 are repeated for the dynamic set of variables forming the index. Thus, at any point of time, the database 102 stores the dynamic set of the variables having a variable value, wherein the dynamic set defines an index of variables.

Another example may be illustrated in conjunction of FIG. 2 to depicts steps to build an index from a first set of variables according to an embodiment of the invention. According to an embodiment of the invention, the first set of variables comprises of sales data for auto companies. Further, the variable value here is the frequency or the number of cars sold in particular period. Thus, according to the embodiment of the invention, the first set of variables comprises of sales data for different companies in the auto sector. Further, as an instance, the initial value of the first set of variables may be defined as the monthly frequency for 100 companies in auto sector for a period of n months, wherein n may be any numerical value programmed in the Indexing system 100 or provided as input by the administrator of the Indexing system 100. Thus, the processor 104 fetches the sales number of the 100 companies and from a database (the distributed database 108).

At step 204, the processor ranks the first list of variables having 100 companies and their sales data, based on the ranking algorithm, Indian Patent Application No. 1844/DEL/2013 on a percentile basis, giving the most sales number auto company a score of 100 and the least sales number for an auto company a score of 1. The ranking algorithm, according to an embodiment, ranks the first set of variables comparing the sales data over a period of time, or the indexed value of the sales data value over the time.

After the first set of variables has been ranked, at the next step 206, the processor 104 selects a second set of variables from the first set of variables based on a condition set wherein the second set of variables forms the dynamic variables of the index. Conditions are based on Variable Value, Ranking of variable value, Basket (portfolio) value, ranking basket (portfolio) value, characteristic or a combination of conditions. These conditions determine the acquiring (Entry) and or discarding (Exit) of a component in or out of a basket (portfolio) or the first set of variable. The condition set comprises both a ranking filter and a variable value filter, with of one or more conditions to select variables from the ranked first set of variables. For example, the ranking filter may specify that the processor 104 selects those variables from the ranked first set of variables, which are:

a. in the top X % ranked variables by variable value in the first set of variables, wherein 0<X<100; and
b. the ranking period is restricted to K months, wherein K is any time period in months,

The processor 104 then selects the variables from the ranked first set of variables to form a second set of variables based on condition sets comprising condition a and b. Thus, the condition set may be single or multiple.

In the next step 208, the processor 104 tests the first set of variables for entry conditions. Thus, the elements of the first set of variables are tested for the entry conditions comprising first 100 ranked auto companies.

Further, the processor 104 assigns weights to each of the variables of the second set of variables according to rankings of the 100 companies in the ranked first set of auto companies. Further, the administrator of the Indexing system 100 may allocate equal resources to the 100 companies.

Further, after an exit time interval of 12 months, the performance of each of the variables in the second set of variables as well as performance of the index (combined performance of the second set of the variables) is analyzed by the processor 104. The basket is rebalanced by ranking the auto companies and discarding the companies from the basket which rank out side 100. Thus, newer companies become part of the basket or portfolio or the second set of the variables every month. Further, cumulative performance measurement of the second set of variable at the end of the year forms the performance of the index. The rebalanced second set of variables thus form the dynamic set of variables.

In the next step 210, steps 202 to step 208 are repeated for the dynamic set of variables forming the auto sales index. Thus, at any point of time, the database 102 stores the dynamic set of the variables having a variable value, wherein the dynamic set defines the auto sales index.

Another illustration with an instance of variable as a financial variable is depicted below to build an index from a first set of variables in conjunction with steps 202-208 of FIG. 2. The step 202 involves selecting the first set of variables, wherein the first set of variables is selected from the universe of variables. According to the embodiment of the invention, the first set of variables is the equities listed in the New York Stock Exchange. The price of the equities refers to the respective values of the variables. The processor 104 fetches the equity list and the corresponding prices from the NYSE server (the distributed database 108).

At step 204, the processor ranks the first list of variables based on a ranking algorithm on a ranking time period. It may be apparent to a person skilled in the art that any ranking algorithm that can rank the first list of variables in a certain order using variable values may be used to rank the first set of variables. The ranking algorithm, according to an embodiment, ranks the first set of variables comparing the share prices or the traded volume of the shares over a period of time, or the indexed value of the share prices over the time.

After the first set of variables has been ranked, at the next step 206, the processor 104 selects a second set of variables from the first set of variables based on a condition set, wherein the second set of variables forms the variables of the index. The condition set comprises of one or more conditions to select variables from the ranked first set of variables. For example, the condition set may specify that the processor 104 selects those variables from the ranked first set of variables, which are:

the top 20% ranked variables in the first set of variables; and
the last 10% ranked variables in the first set of variables; and
the ranking period to be restricted to six months.

The processor 104 then selects the variables from the ranked first set of variables to form a second set of variables based on condition sets comprising condition a, b and c. The condition sets may be either programmed or scheduled or user-defined and may be provided by the user through the input-output medium 106. Examples of the condition set are described in conjunction with the embodiments of the invention in the description below.

In the next step 208, the processor 104 assigns weights to each of the variables of the second set of variables according to weighing algorithm or allocation rules. The unit or plurality of units in percentile, numeric, currency, notional, discretionary, monetary or non-monetary terms to a component or a variable from a basket or portfolio or the second set of equities. This allocation defines the component (components) weight (weighting) in the basket. This weight (weighting) can be equal, unequal, discretionary, proportional, disproportional, condition based and may be programmed or user defined, etc.

The percentage of non-allocated units can also be referred to as CASH UNITS. Further, a resource is proportionately allocated to each of the variables of the second set of variables in proportion to the weights assigned according to allocation rules defined by the administrator or user of the Indexing system 100. The resource may refer to cash allocated for performance evaluation or a value allocated for a non-financial object for the objective evaluation of the second set of variables. For example, a fund manager may allocate 500 million dollar to the second set of variables that comprises of company names listed in a stock exchange. Thus, 500 million dollars may be invested on different companies present in the second set of variables according to weights being assigned to each of the company based on its ranking. It may be noted that a user or an administrator may define weights for each of the variables in the second set of variables based on a user defined algorithm. Examples of the user defined algorithm are described in conjunction with the embodiments of the invention in the description below.

Further, after an exit time interval, which in turn is determined by the exit conditions, the performance of each of the variables in the second set of variables is analyzed by the processor 104 along with the performance of the second set of the variables, forming the index. The exit time period is user defined or may be determined by an algorithm defined in the processor 104. The user or administrator may provide the exit time through the input-output medium 106. After the exit time period, the performance of the second set of variables is evaluated based on exit conditions. Here the second set of variables are rebalanced by replacing underperforming (or outperformance or as the Indexing preference may specify) variable in the second set of variables with another variable from the first set of variables. For example, the exit conditions may comprise of comparing the net variable value of the second set of variables for a time period one with the net variable value of the second set of variables for a time period two, wherein time period one and time period two are time spans provided by the user. Thus, performance measurement of the second set of variable at the end of the exit time period is defined by the user based on the user defined exit conditions. Further, based on performance criteria, variables may be replaced from the second set of variables with the variables from the first set of variables. The performance criteria may again be programmed into the processor 104. The performance criteria may define if the current performance of the index is say 20% less than the previous performance. It may be apparent to a person skilled in the art that any other performance criteria to rebalance the index may be used. Further, the cumulative variable value of the second set of variables determines an index value of the second set of the variables. The rebalanced second set of variables thus form the dynamic set of variables.

In the next step 210, steps 202 to step 208 are repeated for the dynamic set of variables forming the index. Thus, at any point of time, the database 102 stores the dynamic set of the variables having a variable value, wherein the dynamic set defines an index of variables.

Indexing preference determines the styles in which the conditions will select a set of variables to form the Index. Indexing preference styles can be referred to as Active, Extreme Reversion, Value, Growth, Value-Growth, Momentum, Relative Performance, Tactical, Short, Long-Short, Hedge, Sentiment, Options and Hybrid Styles before the following sections which provides a snapshot of some of the styles.

Active Style:

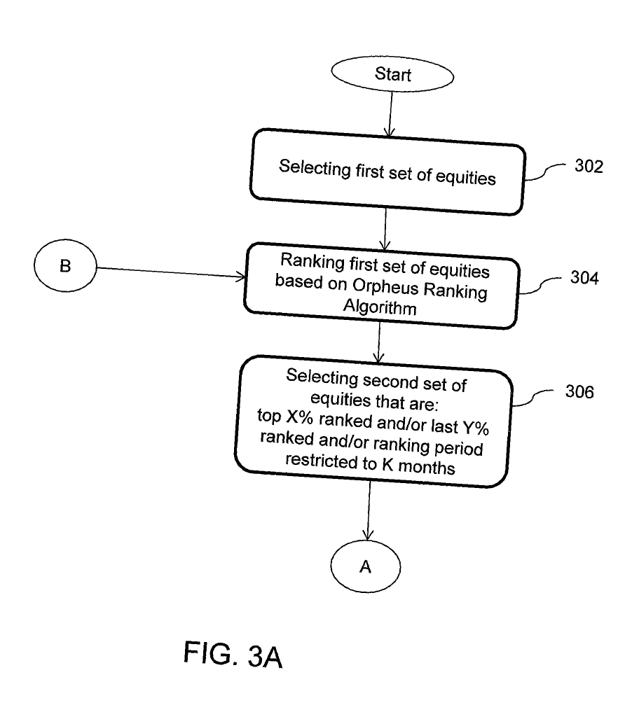

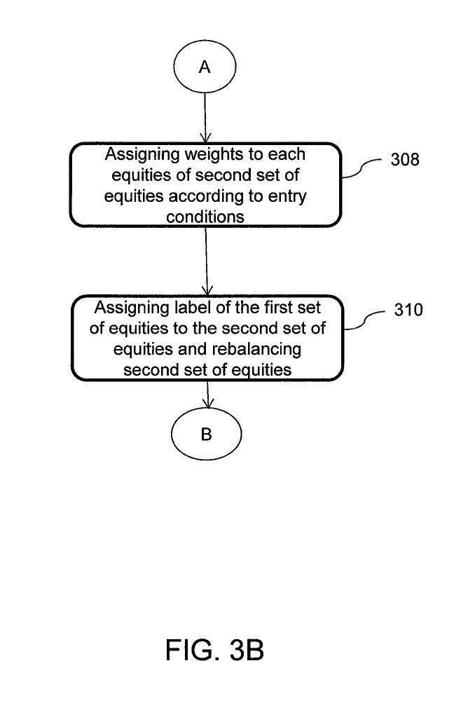

FIGS. 3A and 3B depicts steps to build an index for a first set of variables according to an embodiment of the invention.

The step 302 involves selecting the first set of variables, wherein the first set of variables is selected from the universe of variables. According to an embodiment of the invention, the first set of variables is the equities listed in the New York Stock Exchange. The equity price of the equities is the variable values of the variables. The processor 104 fetches the equity list and the corresponding prices from the NYSE server (the distributed database 108).

At step 304, the processor ranks the first list of equities based on a ranking algorithm on a ranking time period. The ranking algorithm is based on multi temporal, variable and inters variable ranking system, and is referred to as Orpheus ranking method in Indian Patent Application No. 1844/DEL/2013. The method described in Indian Patent Application No. 1844/DEL/2013, is included herein by reference.

After the first set of equities has been ranked, at the next step 306, the processor 104 selects a second set of equities from the first set of equities based on a condition set, wherein the second set of equities forms the equities of the index. According to the embodiment, the condition set comprises of one or more conditions to select the equities from the ranked first set of equities. The condition set may specify a ranking filter as well as price filter, wherein one or any combination of the following conditions are specified:

Ranking Filter:

the top X % ranked equities in the first set of equities, wherein 0<X<100;
the last Y % ranked equities in the first set of equities, wherein 0<Y<100;
the ranking period to be restricted to K months, wherein K is any time period in months;
Price filter: the user may specify a condition on the price movement of the equities. For example,
N period DMAVariable Value (Daily Mean Average value of the equity for N time periods) is greater than or M Period DMA Variable value (Daily Mean Average value of the equity for M time periods) of the equity is less than the value of the stock, wherein M and N are time periods in months and may be specified by the user. Further, it would be apparent to a person skilled in the art that M and N may be specified in minutes, hours, days or any other unit of time.

The processor 104 then selects the equities from the ranked first set of equities to form a second set of equities based on the condition set. In the condition set the user may define X, Y and K along with preferred combination of the conditions a, b, c or d, through the input-output medium 106. Further, the processor 104 also processes the entry timing in a particular equity or plurality of equities, choosing the timing and the stock which are best for investment. For example, the processor may choose equity or plurality of equities if it satisfies the criterion that value of the stock at any point is greater than the variable value of the stock in a particular time period. It would be apparent to a person skilled in the art that any other entry condition may be specified to select the equity.

In the next step 308, the processor 104 assigns unit or plurality of units to the components or variables from a basket or portfolio or the second set of equities. This allocation defines the component or the plurality of components' weight in the second set of equities.

The processor 104 may invest a user specified percentage of fund to the second set of equities which is then proportionately allocated to each of the equities in the second set of equities in proportion to the weights assigned. For example, a fund manager may allocate 50 million dollars or 10% of the 500 million dollars fund to the second set of equities. Thus, 50 million dollars may be invested on different companies present in the second set of equities according to weights being assigned to each of the company based on its ranking.

Further, after an exit time interval, the performance of each of the equities in the second set of equities is analyzed by the processor 104. The exit time period is user defined or may be determined by an algorithm defined in the processor 104. The user or administrator may also input the exit time through the input-output medium 106. Now at the exit time period, the performance of the second set of equities is evaluated based on exit conditions. For example, the exit conditions may comprise of comparing the net variable value of the second set of equities for a first time period with the net variable value of the second set of equities for a second time period, wherein the first time period and the second time period are two time spans provided by the user. Hence, entry conditions and exit conditions define the performance of the second set of the equities. Thus, at any point of time, the database 102 stores the dynamic set of the equities having a variable value, wherein the dynamic set defines an active index of equities.

In the next step 310, steps 302 to step 308 are repeated for user-defined time periods on the active index or the dynamic set of equities.

It would be apparent to a person skilled in the art that different entry conditions, condition set, weighting algorithms and the exit conditions may be changed to obtain different styles of indexes. Following instances of the entry and exit conditions are some of the other embodiments of the invention.

1) The extreme reversion style—All the other steps (302-304) remaining identical, in the step 306, all the ranked variables of the first set of variables form the elements of the second set of variables. In the next step 308, the processor 104 assigns weights to each of the variables of the second set of variables according to entry conditions. Here the weights are defined by following method. A maximum weight (MAX weight) is defined to be equal to N×Weight age variable defined by the user, wherein N is the number of variables in the second set of variables. Also, a minimum weight (MIN weight) is defined. Thereafter, weights are assigned for each of the variables, wherein maximum weight is assigned to the least ranked variable while minimum weight is assigned to the top ranked variable.

Further, exit conditions here define the exit time interval, after which the value of the second set of variables is registered by the processor 104. The exit time period may be user defined or the processor 106 programmed. For example, the exit time period may be any of the values of the time periods, for example 30, 60, 90,120,180 or 210 months. The time period may be specified in minutes, hours, days, months or any other unit of time. In the next step 310, the processor 104 dynamically assigns the label of the first set of variables to the second set of variables. Thus, at any point of time, the database 102 stores the dynamic set of the equities having a variable value, wherein the dynamic set defines an active index of equities.

In the next step 310, steps 302 to step 308 are repeated for user-defined time periods on the index or the dynamic set of equities.

1) The Momentum style—All the other steps (302-304) remaining identical, in the step 306, all the ranked variables of the first set of variables form the elements of the second set of variables. In the next step 308, the processor 104 assigns weights to each of the variables of the second set of variables according to entry conditions. Here the weights are defined by following method. A maximum weight (MAX weight) is defined to be equal to N×Weight age variable defined by the user, wherein N is the number of variables in the second set of variables. Also, a minimum weight (MIN weight) is defined. Thereafter, weights are assigned for each of the variables, wherein maximum weight is assigned to the top ranked variable while minimum weight is assigned to the bottom ranked variable.

Further, exit conditions here define the exit time interval, after which the value of the second set of variables is registered by the processor 104. The exit time period may be user defined or the processor 106 programmed. For example, the exit time period may be any of the values of the time periods, for example 30, 60, 90,120,180 or 210 months. The time period may be specified in minutes, hours, days, months or any other unit of time. In the next step 310, the processor 104 dynamically assigns the label of the first set of variables to the second set of variables. Thus, at any point of time, the database 102 stores the dynamic set of the equities having a variable value, wherein the dynamic set defines an active index of equities.

In the next step 310, steps 302 to step 308 are repeated for user-defined time periods on the index or the dynamic set of equities.

2) Value X Percentile Style—All the other steps (302-304) remaining identical, after the first set of variables has been ranked, at the next step 306, the processor 104 selects a second set of variables from the first set of variables based on a condition set, comprising a ranking filter, wherein the Bottom X % ranked equities in the first set of equities are selected, wherein 0<X<100. Further, the processor 104 also processes the entry timing in a particular variable or plurality of variables, choosing the timing and the stock which are best for investment. For example, the processor 104 may choose equity or plurality of equities if it satisfies the criterion that value of the stock at any point is greater than the variable value of the stock in a chosen time period. Further, the processor 104 may invest a user specified percentage of fund to the second set of equities which is then proportionately allocated to each of the equities in the second set of equities in proportion to the weights assigned by the user or are distributed based on a user defined algorithm. For example, a fund manager may allocate 50 million dollars or 10% of the 500 million dollars fund to the second set of equities. Thus, 50 million dollars may be invested on different companies present in the second set of equities equally (weights for each are same) or unequally (different variables have different weights) assigned to each of the company based on allocation rule.

Further, exit conditions in the Value X percentile define the exit time period, after which the value of the second set of variables is registered by the processor 104. The exit time period may be user defined or the processor 106 programmed. For example, the exit time period may be any of the values of the time periods, for example 30, 60, 90,120,180 or 210 months. The time period may be specified in minutes, hours, days, months or any other unit of time. It is after the exit time period wherein certain variables are removed from the list and a new variable is chosen to rebalance the index. Thus, exit time period acts as a rebalancing time period. After the rebalancing of the second set of variables, steps 302 to step 308 are repeated for on the dynamic set of variables formed forming the index. Thus, at any point of time, the database 102 stores the dynamic set of the variables having a variable value, wherein the dynamic set defines an index of variables.

It will be apparent to a person skilled in the art that certain embodiments and instances of different condition sets, entry conditions, exit condition set, exit time periods and weights of the variables have been described above, however, other condition sets and their variations, entry conditions, exit condition set, exit time periods and weights of the variables would represent different styles of indices of representing a set of variables. Examples of different styles include but not limited to extreme reversion, value, growth, value-growth, momentum, relative performance, tactical, short, long-short, hedge, sentiment, options. Further, it may be apparent to a person skilled in the art that the process as described in conjunction with FIG. 2 may be analyzed to predict meaningful information about a set of data variables (variables) over a period of time.

Growth Percentile Style—All the other steps (302-304) remaining identical, after the first set of variables has been ranked, at the next step 306, the processor 104 selects a second set of variables from the first set of variables based on a condition set, comprising a ranking filter, wherein the Top X % ranked equities in the first set of equities are selected, wherein 0<X<100. Further, the processor 104 also processes the entry timing in a particular variable or plurality of variables, choosing the timing and the stock which are best for investment. For example, the processor 104 may choose equity or plurality of equities if it satisfies the criterion that value of the stock at any point is greater than the variable value of the stock in a chosen time period. Further, the processor 104 may invest a user specified percentage of fund to the second set of equities which is then proportionately allocated to each of the equities in the second set of equities in proportion to the weights assigned by the user or are distributed based on a user defined algorithm. For example, a fund manager may allocate 50 million dollars or 10% of the 500 million dollars fund to the second set of equities. Thus, 50 million dollars may be invested on different companies present in the second set of equities equally (weights for each are same) or unequally (different variables have different weights) assigned to each of the company based on allocation rule.

Further, exit conditions in the Growth X percentile define the exit time period, after which the value of the second set of variables is registered by the processor 104. The exit time period may be user defined or the processor 106 programmed. For example, the exit time period may be any of the values of the time periods, for example 30, 60, 90, 120,180 or 210 months. The time period may be specified in minutes, hours, days, months or any other unit of time. It is after the exit time period wherein certain variables are removed from the list and a new variable is chosen to rebalance the index. Thus, exit time period acts as a rebalancing time period. After the rebalancing of the second set of variables, steps 302 to step 308 are repeated for on the dynamic set of variables formed forming the index. Thus, at any point of time, the database 102 stores the dynamic set of the variables having a variable value, wherein the dynamic set defines an index of variables.

It will be apparent to a person skilled in the art that certain embodiments and instances of different condition sets, entry conditions, exit condition set, exit time periods and weights of the variables have been described above, however, other condition sets and their variations, entry conditions, exit condition set, exit time periods and weights of the variables would represent different styles of indices of representing a set of variables. Examples of different styles include but not limited to extreme reversion, value, growth, value-growth, momentum, relative performance, tactical, short, long-short, hedge, sentiment, options. Further, it may be apparent to a person skilled in the art that the process as described in conjunction with FIG. 2 may be analyzed to predict meaningful information about a set of data variables (variables) over a period of time.

Value-Growth Percentile Style—All the other steps (302-304) remaining identical, after the first set of variables has been ranked, at the next step 306, the processor 104 selects a second set of variables from the first set of variables based on a condition set, comprising a ranking filter, wherein the Top X % and Bottom Y % ranked equities in the first set of equities are selected, wherein 0<X<100. Further, the processor 104 also processes the entry timing in a particular variable or plurality of variables, choosing the timing and the stock which are best for investment. For example, the processor 104 may choose an equity or plurality of equities if it satisfies the criterion that value of the stock at any point is greater than the variable value of the stock in a chosen time period. Further, the processor 104 may invest a user specified percentage of fund to the second set of equities which is then proportionately allocated to each of the equities in the second set of equities in proportion to the weights assigned by the user or are distributed based on a user defined algorithm. For example, a fund manager may allocate 50 million dollars or 10% of the 500 million dollars fund to the second set of equities. Thus, 50 million dollars may be invested on different companies present in the second set of equities equally (weights for each are same) or unequally (different variables have different weights) assigned to each of the company based on allocation rule.

Further, exit conditions in the Value-Growth X percentile define the exit time period, after which the value of the second set of variables is registered by the processor 104. The exit time period may be user defined or the processor 106 programmed. For example, the exit time period may be any of the values of the time periods, for example 30, 60, 90, 120,180 or 210 months. The time period may be specified in minutes, hours, days, months or any other unit of time. It is after the exit time period wherein certain variables are removed from the list and a new variable is chosen to rebalance the index. Thus, exit time period acts as a rebalancing time period. After the rebalancing of the second set of variables, steps 302 to step 308 are repeated for on the dynamic set of variables formed forming the index. Thus, at any point of time, the database 102 stores the dynamic set of the variables having a variable value, wherein the dynamic set defines an index of variables.

It will be apparent to a person skilled in the art that certain embodiments and instances of different condition sets, entry conditions, exit condition set, exit time periods and weights of the variables have been described above, however, other condition sets and their variations, entry conditions, exit condition set, exit time periods and weights of the variables would represent different styles of indices of representing a set of variables. Examples of different styles include but not limited to extreme reversion, value, growth, value-growth, momentum, relative performance, tactical, short, long-short, hedge, sentiment, options. Further, it may be apparent to a person skilled in the art that the process as described in conjunction with FIG. 2 may be analyzed to predict meaningful information about a set of data variables (variables) over a period of time.

Relative Performance, Tactical, Short, Long-Short, Hedge, Sentiment, Options and Hybrid Styles are Indexing preferences which adopt different combination of conditions to select variables and measure index performance.

The embodiments of the invention described above are intended for the purpose of illustration only. Numerous modifications, changes, variations, substitutions and equivalents will be apparent to those skilled in the art without departing from the spirit and scope of the invention as described in the claims.

What is claimed is:

1. A method of forming an index, comprising the steps of:
i. selecting a first set of variables, wherein the first set of variables is selected from a group of variables;
ii. ranking the first set of variables on a ranking time period;
iii. selecting a second set of variables based on a condition set, wherein the second set of variables form the variables of the index, wherein the second set of variables is selected from the first set of variables;
iv. assigning weights to each of the variables of the second set of variables, wherein a resource is proportionately allocated to each of the variables of the second set of variables in proportion to the weights assigned;
v. analyzing the performance of each of the variables in the second set of variables after an exit time interval, wherein indexed value of the variables in the second set of the variables is measured; and
vi. repeating the steps from (ii) through (v) for a defined period of time, wherein the second set of variables is a dynamic set of variables forming the index.

2. The method step as claimed in claim 1, wherein ranking the first set of variables on a ranking time period is done by a ranking methodology on variable values of the variables, wherein the ranking may be numeric or a percentile ranking.

3. The method step as claimed in claim 1, wherein the variable is sentiment data for a company and the variable value is the sentiment data value, wherein the sentiment data value is the frequency of occurrence of the name of the company on social websites, search results and other online resources on Internet.

4. The method step as claimed in claim 1, wherein the variable is equity and the variable value is the market price of the equity.

5. The method step as claimed in claim 1, wherein the resource is cash fund, wherein the cash fund is proportionately allocated funds to each of the variables of the second set of variables in proportion to the weight assigned to each of the variables.

6. The method step as claimed in claim 1, wherein analyzing the performance of each of the variables in the second set of variables after an exit time interval further comprises rebalancing the second set of variables, wherein the components of the second set of variables are rebalanced with the components of the first set of variables based on a set of conditions on the performance of the components of the second set of conditions.

7. The method step as claimed in claim 1, wherein the variable is a financial object and the variable value is the market value of the financial object.

8. The method step as claimed in claim 1, wherein the variable is a non-financial object and the variable value is an objective measure of the non-financial object.

9. The method step as claimed in claim 1, wherein the condition set is defined as the filtering of the first set of variables to obtain the second set of variables satisfying at least one criterion.

10. A computer system of forming an index, the computer system comprising:
a. at least one database; and
b. at least one processor, the at least one processor capable of performing the steps of:
i. selecting a first set of variables, wherein the first set of variables is selected from a universe of variables;
ii. ranking the first set of variables on a ranking time period;
iii. selecting a second set of variables based on a condition set, wherein the second set of variables form the variables of the index;
iv. assigning weights to each of the variables of the second set of variables;
v. allocating funds to each of the variables of the second set of variables in proportion of the weight assigned to each of the variables;
vi. analyzing the performance of each of the variables of the second set of variables after an exit time interval;
vii. registering the index value, wherein the index value is the indexed value of the variables in the second set of the variables; and
viii. repeating the steps from (ii) through (vii) for a defined period of time, wherein the second set of variables is a dynamic set of variables forming the index.

11. The computer system as claimed in claim 10, wherein ranking the first set of variables on a ranking time period is done by a ranking methodology.

12. The computer system as claimed in claim 10, wherein the variable is equity and the variable value is the market price of the equity.

13. The computer system as claimed in claim 10, wherein the variable is the product and the variable value is the product sentiment value on the Internet.

14. The computer system as claimed in claim 10, wherein the variable is a financial object and the variable value is the market value of the financial object.

15. The computer system as claimed in claim 10, wherein the variable is a non-financial object and the variable value is an objective measure of the non-financial object.

16. The computer system as claimed in claim 10, wherein the condition set is defined as the filtering of the first set of variables to obtain the second set of variables satisfying at least one criteria.

17. The computer system as claimed in claim 10, wherein analyzing the performance of each of the variables in the second set of variables after an exit time interval further comprises rebalancing the second set of variables, wherein the components of the second set of variables are rebalanced with the components of the first set of variables based on a set of conditions on the performance of the components of the second set of conditions.
